(19) United States
(12) Patent Application Publication
(10) Pub. No.: US 2005/0015220 A1
(43) Pub. Date: Jan. 20, 2005

(54) AUTOMATIC APPLICATION PROGRAMMING INTERFACE (API) DETECTION AND METHODS OF USE THEREOF

(75) Inventor: Rajesh G. Ramchandi, Santa Clara, CA (US)

Correspondence Address: BEYER WEAVER & THOMAS LLP, P.O. BOX 778, BERKELEY, CA, 94704-0778, US

(73) Assignee: SUN MICROSYSTEMS, INC., SANTA CLARA, CA (US)

(21) Appl. No.: 10/604,399

(22) Filed: Jul. 17, 2003

(51) Int. Cl. G06F 15/00

(52) U.S. Cl. 702/188

(57) ABSTRACT

A method, apparatus and system arranged to provide API detection that allows a client to interrogate a particular server computer to automatically return those interfaces and associated remote methods required for communication with the server. In this way, the client can be incorporated into the network of electronic devices serviced by the server computer. A list of application programming interfaces (APIs) and/or exported remote methods is requested to an automatic API detection enabled server computer by the electronic device. The server responds to the request by providing a comprehensive list of APIs and remote methods by the server computer to the electronic device that is used by the electronic device to connect to the server computer. In this way, the electronic device uses selected ones of the list of APIs and remote methods to communicate with other members of the network by way of the server computer.

### BACKGROUND OF INVENTION

The invention relates generally to computer systems and embedded devices. More particularly, in a server environment, methods and apparatus for automatically detecting available application programming interfaces either remotely or locally.

Historically, a network of computing devices has typically included a number of interconnected personal computers, workstations, mainframes, and the like along with other devices such as large mass storage subsystems. More recently, however, with the advent of embedded processing, computing networks can now include a multitude of thin client devices (having minimal processing capability) such as cell phones, personal digital assistants and/or those devices having embedded processors. Those devices having embedded processors can include a wide variety of instruments ranging from simple household appliances (refrigerators, cook tops, etc.) to exercise equipment (treadmills, stationery bicycles, and the like), and any other device for which an embedded process can provide added utility. In each of these cases, however, in order to connect each device to a particular network, a device must present what is referred to as an application programming interface, or API. More precisely, an application program interface is the specific method prescribed by a device's operating system or by an application program by which a requester (be it another device or an individual) can make requests of the operating system or another application. Unfortunately, as currently implemented, networked devices such as servers and networked appliances do not provide any information regarding the programming interfaces or the remote methods required for a client to communicate with a particular server or networked appliance. In order to communicate, therefore, a client must determine the appropriate remote methods and/or APIs by performing a search (such as in various registries or device documentation, if available) or other such indirect approaches since the client cannot communicate with the server until such information is known.

Accordingly, at present, there is no mechanism by which a server can provide API information to clients at runtime. In most of the client-server applications, the client should know at compile time the interfaces that are supported by the server. For example, in the web services environment, the client must retrieve information about the supported remote interfaces through an XML file stored either at the server location of a registry server. Unfortunately, it is often very tedious for each client to obtain information, parse it, and then call remote methods of a web service. In such an environment, if any interfaces at web service change or the web service implements new interfaces, the new XML file describing these interfaces must be created and updated in the registry server. The client software then has to be recompiled to use new or modified interfaces.

Therefore what is required is a mechanism that allows a client to interrogate a particular server computer to automatically return those interfaces and associated remote methods required for communicating with the server.

### SUMMARY OF INVENTION

Broadly speaking, the invention relates to a method, apparatus and system that allows a client to interrogate a particular server computer to automatically return those interfaces and associated remote methods required for communicating with the server. In one embodiment, a method of automatically detecting a number of application program interfaces (APIs) and/or remote methods associated with a server computer is described. The method includes operations such as requesting a list of the APIs and/or the exported remote methods from the server computer, and providing the list of APIs and/or remote methods in response to the request.

As a method, at least one of a member of networked electronic devices sends an API request command to a non-member electronic device. When auto API detection enabled, the non-member electronic device responds to the request by providing a comprehensive list of application programming interfaces (APIs) and exported remote methods. In this way, the responding device can become a communicating member of the network by allowing other members of the network access to the appropriate APIs and remote methods.

In another embodiment, an apparatus for incorporating an electronic device into a network of electronic devices having at least one automatic API detection enabled server computer is described. The apparatus is formed of at least a means for requesting a list of application programming interfaces (APIs) and/or exported remote methods from the electronic device to automatic API detection enabled server computer by the electronic device. A means for responding to the request by providing a comprehensive list of APIs and remote methods by the server computer to the electronic device. Also included is a means for connecting to the server computer by the electronic device using the comprehensive list of application programming interfaces (APIs) and exported remote methods wherein the electronic device uses selected ones of the list of APIs and remote methods to communicate with other members of the network by way of the server computer.

In yet another embodiment, a computer program product for incorporating an electronic device into a network of electronic devices having at least one automatic API detection enabled server computer is described. Computer code for requesting a list of application programming interfaces (APIs) and/or exported remote methods from the electronic device to automatic API detection enabled server computer by the electronic device, computer code for responding to the request by providing a comprehensive list of APIs and Remote methods by the server computer to the electronic device, computer code for connecting to the server computer by the electronic device using the comprehensive list of application programming interfaces (APIs) and exported remote methods wherein the electronic device uses selected ones of the list of APIs and remote methods to communicate with other members of the network by way of the server computer, and computer readable medium for storing the computer code.

### BRIEF DESCRIPTION OF DRAWINGS

The invention, together with further advantages thereof, may best be understood by reference to the following description taken in conjunction with the accompanying drawings.

FIG. 1 shows system having an automatic API detection enabled server and a client in accordance with an embodiment of the invention.

FIG. 2 shows an exemplary heterogeneous network in accordance with an embodiment of the invention.

FIGS. 3A-3B shows another exemplary heterogeneous network in accordance with an embodiment of the invention.

FIG. 4 shows a flowchart detailing a process for forming a heterogeneous network in accordance with an embodiment of the invention.

FIG. 5 illustrates a computer system that can be employed to implement the present invention.

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one embodiment of the present invention, there is described a method, apparatus and system for automatic API detection that allows a client to interrogate a particular server computer to automatically return those interfaces and associated remote methods required for communication with the server. In this way, the client can be incorporated into the network of electronic devices serviced by the server computer. Such devices can include network appliances, computers, and other embedded devices. As a method, a list of application programming interfaces (APIs) and/or exported remote methods is requested to an automatic API detection enabled server computer by the electronic device. The server responds to the request by providing a comprehensive list of APIs and Remote methods by the server computer to the electronic device that is used by the electronic device to connect to the server computer. In this way, the electronic device uses selected ones of the list of APIs and remote methods to communicate with other members of the network by way of the server computer.

Accordingly, automatic API detection provides for any electronic device, appliance embedded server, web service, etc. to be networked for the purpose of communication with the outside work has the ability to identify itself to the networked community on request from external entities, web service clients and/or any software clients. In one embodiment, the identification includes a comprehensive list of application programming interfaces (APIs) and exported remote methods. The invention is well suited for use in embedded devices, network appliances, remote servers and any other server that must be networked in a heterogeneous network. It should be noted that in the context of this discussion, the term heterogeneous refers to devices having similar functions but manufactured by different vendors.

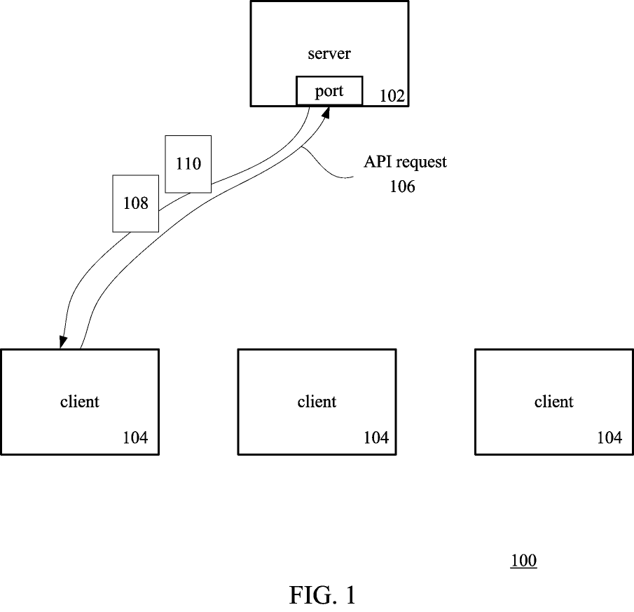

Accordingly, FIG. 1 shows system 100 having an automatic API detection enabled server 102 and a client 104 in accordance with an embodiment of the invention. It should be noted that the server 102 can be any server or web service that can listen and accept a server API request 106 from the client 104. Typically, the server API request 106 provides a formal request to the server 102 for a list of application programming interfaces (APIs) that the server 102 supports in addition to, in some cases, a list of exported interfaces or remote methods that the server 102 allows the client 104 to invoke using some or any protocols (such as HTTP, RMI, SOAP messages, or Remote Procedure Calls (RPCs) as well as any non-standard protocols).

During operation, the server 102 listens for the server API request 106 from the client 104 on standard ports, such as port 443 as well as any appropriate port depending on if the client-server communication is secure or not. It is well known in the art that the port 443 is the standard port for HTTPS protocol that uses SSL for secure connection and communication between the server 102 and the client 104. In order to obtain the list, the client 104 establishes a connection in a known format with the server 102 and, thereafter, makes a request 112 of the server 102 for the APIs or remote methods that the server 102 supports. For example, the client 104 can make the request 112 on the secure port 443 using HTTPS protocol, or a server advertised port for using RMI protocol. In response, the server 102 provides the client 104 with the requested information and, optionally, the client 104 also is provided information on the classification schema that the server 102 used to classify the API and remote methods. In this regard, the server 102 provides any appropriate schema that provides a list of APIs 108 and remote methods 110 or that the client 104 can use to identify the APIs and methods. In this way, the server 102 is capable of providing a list of APIs in a well defined classification format. One such classification schema is referred to as the North American Industry Classification Scheme, or NAICS.

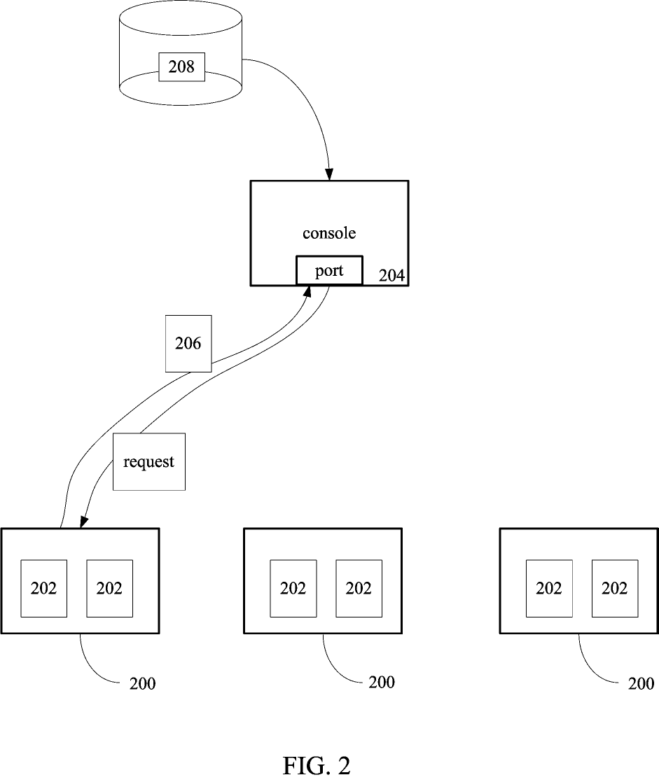

The invention therefore provides a simple technique for incorporating an electronic device into a heterogeneous network thereby providing a practical and easily implemented approach to networking functionally similar devices from disparate manufacturers. One such example is described with respect to FIG. 2 where a hypothetical organization (API Gym Corp. for example) has a number of gym sites 200. Each gym site has a number of treadmills 202 of various manufacturers and model types in that each model has an associated set of features and controls. Such features and controls include a common subset of controls for speed, elevation, pre-programmed workouts (i.e., Fat Burner mode, Cardio Mode, Manual Mode, heart rate monitor mode, etc.). In order to run a new workout program from a central location, the various treadmills 202 must be networked together to form a heterogeneous network along the lines discussed above. In order to network the various treadmills 202, at the least, the various speed controls, elevation controls and other functional controls must be known which can be accomplished by providing a software module that exposes the various methods and/or commands to control those functions controllable remotely by the console 204. In this case, the console 204 is analogous to the client which sends an API/remote method request to each of the treadmills to be included in the network. Each of the treadmills 202 (as the API enabled server), in turn, provides a list of methods or APIs 206 that can be used to control the various functions by way of the console 204. Once received by the console 204, the list of APIs 206 provides the wherewithal for the console 204 to control each of the treadmills 202. Once the APIs are known, the main console 204 connects to each of the treadmills 202 using the particular APIs and/or remote methods specific to each treadmill. A script file 208 (stored in memory 210, for example) can then be used to program each treadmill 202 to follow a particular workout routine. Such a script file can include, for example, a 30 minute workout routine that provides a 5 minute warm up period, followed by a 20 minute workout (with speed ramping from 5 mph to 20 mph and back again with a associated elevation increase from 0% incline to 10% incline and back again), a 5 minute cool down, and ending with a summary provided.

Therefore, instead of purchasing all new treadmills of the same design and manufacture, the invention provides for a simple and cost effective approach to networking the disparate group of devices into a single, unified, heterogeneous network.

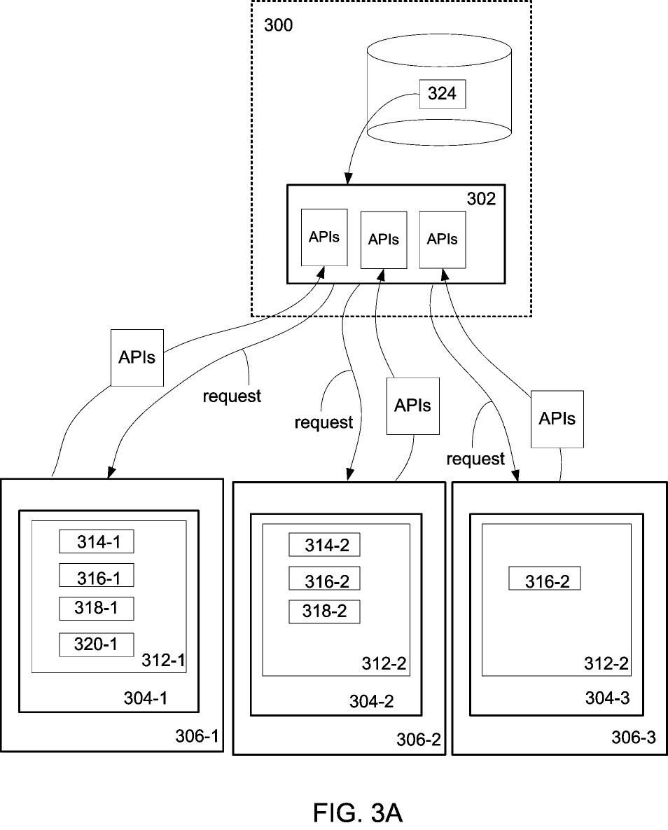

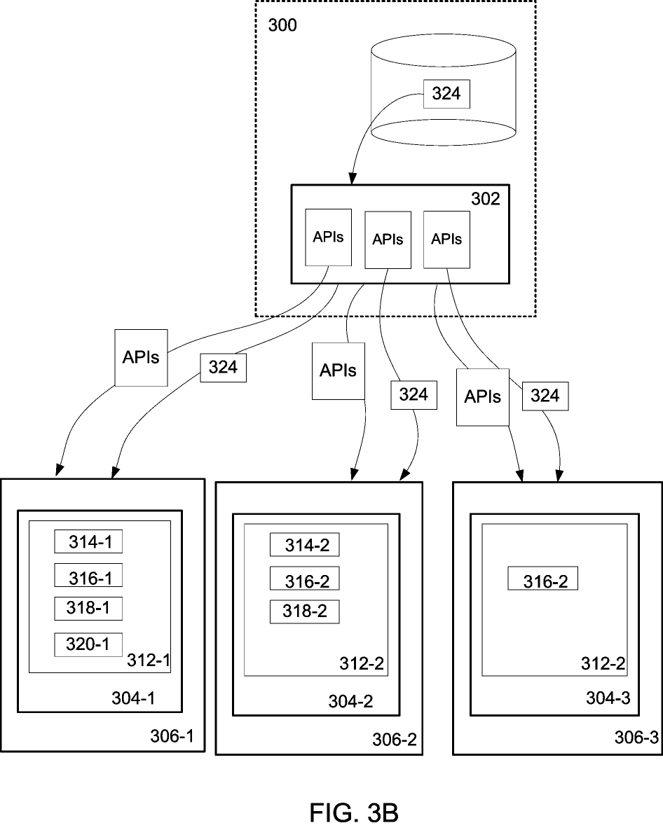

For a specific example, consider the following situation shown in FIG. 3A. World-Wide Gym has a central office 300 that includes at least one client computer 302 used for controlling a number of treadmills 304 spread amongst a number of geographically diverse satellite gyms 306. A fitness coach wishes to provide a workout routine during a workout class at a specific time for a number of patrons dispersed amongst a number of World-Wide Gym satellite gyms. The fitness coach, however, can only be physically located at the central office 300 and only has access to the client computer 302. In this example, the number of treadmills 304 represents a heterogeneous group of in that some of the treadmills 304 are manufactured by different manufacturers, some of the treadmills while manufactured by the same manufacturer are different model types with different features, etc which presents the central office with the difficult task of forming a network of heterogeneous devices based upon the differences in functionalities of the various treadmills. It should also be noted, that some of the functionalities can be remotely controlled whilst others cannot. For example, the treadmill 304-1 located in satellite gym 306-1 is manufactured by the XYZ Treadmill Company having a control panel 312-1 with a speed control 314-1, an elevation control 316-1 (having a range of 0% to 10%), a heart rate monitor 318-1, and an exercise routine control (i.e., Fat Burner, Cardio, Manual, etc.) 320-1. At a satellite gym 306-2, a treadmill 304-2 is manufactured by the ABC Treadmill Company having a control panel 312-2 with a speed control 314-2, an elevation control 316-2 (having a range of 0% to 15%), a heart rate monitor 318-2. Finally, at a satellite gym 306-3, a older version of the treadmill 304-2 is in use (i.e., the treadmill 304-3) having no heart rate monitor and an elevation control 316-2 having a range of only 0% to 10%.

In order to provide the appropriate workout routine, the trainer creates a workout script file 324 into which is inscribed the desired workout routine for the workout class. The script file 324 includes, for example, Such a script file can include, for example, a 30 minute workout routine that provides a 5 minute warm up period, followed by a 20 minute workout (with speed ramping from 5 mph to 20 mph and back again with a associated elevation increase from 0% incline to 10% incline and back again), a 5 minute cool down, and ending with a summary provided.

Accordingly, in order to link the various treadmills 304, the computer 302 sends an API request to each of the treadmills each of which returns the list of appropriate APIs for controlling the various functions. Once the appropriate APIs and/or remote methods are available to the computer 302, each of the treadmills 304 can be networked together in such a way as to be appropriately controlled by the script file 324 as shown in FIG. 3B. It should be noted, however, that not all treadmill functions can be controlled remotely, such as the heart rate monitor, since the use of this function is strictly at the discretion of the user.

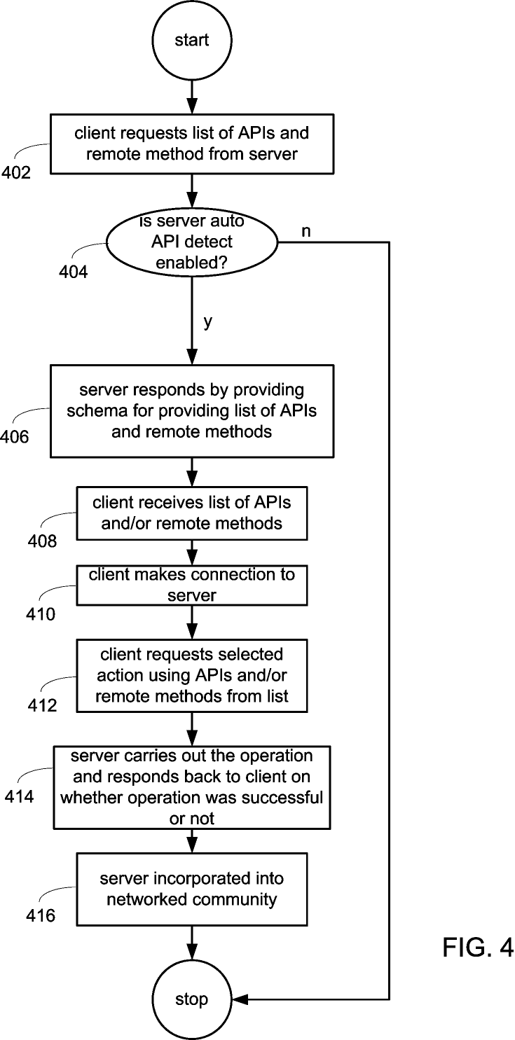

FIG. 4 shows a flowchart detailing a process 400 for incorporating an electronic device into a heterogeneous network in accordance with an embodiment of the invention. The process 400 begins at 402 by the electronic device, otherwise referred to as the client, requesting a list of APIs and remote methods from a server computer. At 404, a determination is made whether or not the server computer is auto API detect capable by which it is meant that the server computer is capable of providing a valid requestor with that information required to access the server. If the server computer is not auto API detect capable, then the process 400 ends, otherwise, the server responds to the client request by providing a list of APIs and remote methods used for accessing the server computer at 406. At 408, the client computer receives the list of APIs and remote methods after which the client computer connects to the server computer at 410. After the connection has been made, the client computer requests selected server actions by use of the API and remote methods list at 412. At 414, the server computer responds to the client's request by carrying out the actions requested by the client and responds back to the client whether the action as successful or not at 416.

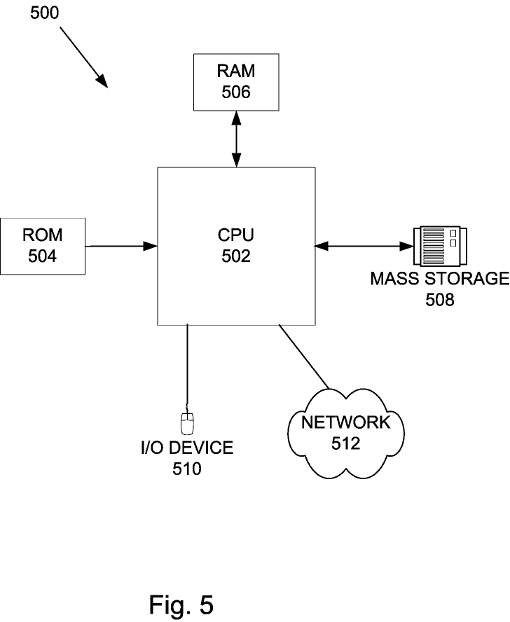

FIG. 5 illustrates a computer system 500 that can be employed to implement the present invention. The computer system 500 or, more specifically, CPUs 502, may be arranged to support a virtual machine, as will be appreciated by those skilled in the art. As is well known in the art, ROM acts to transfer data and instructions unidirectionally to the CPUs 502, while RAM is used typically to transfer data and instructions in a bi-directional manner. CPUs 502 may generally include any number of processors. Both primary storage devices 504, 506 may include any suitable computer-readable media. A secondary storage medium 508, which is typically a mass memory device, is also coupled bi-directionally to CPUs 502 and provides additional data storage capacity. The mass memory device 508 is a computer-readable medium that may be used to store programs including computer code, data, and the like. Typically, mass memory device 508 is a storage medium such as a hard disk or a tape which generally slower than primary storage devices 504, 506. Mass memory storage device 508 may take the form of a magnetic or paper tape reader or some other well-known device. It will be appreciated that the information retained within the mass memory device 508, may, in appropriate cases, be incorporated in standard fashion as part of RAM 506 as virtual memory. A specific primary storage device 504 such as a CD-ROM may also pass data unidirectionally to the CPUs 502.

CPUs 502 are also coupled to one or more input/output devices 410 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 502 optionally may be coupled to a computer or telecommunications network, e.g., an Internet network, or an intranet network, using a network connection as shown generally at 512. With such a network connection, it is contemplated that the CPUs 502 might receive information from the network, or might output information to the network in the course of performing the above-described method steps. Such information, which is often represented as a sequence of instructions to be executed using CPUs 502, may be received from and outputted to the network, for example, in the form of a computer data signal embodied in a carrier wave. The above-described devices and materials will be familiar to those of skill in the computer hardware and software arts.

It should be noted that the present invention employs various computer operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. In particular, various general-purpose computers may be used with programs written in accordance with the teachings herein, or, alternatively, it may be more convenient to construct a more specialized computer system to perform the required operations.

Although only a few embodiments of the present invention have been described, it should be understood that the present invention may be embodied in many other specific forms without departing from the spirit or the scope of the present invention. The invention is well suited for use in embedded devices, network appliances, remote servers and any other server that must be networked in a heterogeneous network. It should be noted that in the context of this discussion, the term heterogeneous refers to devices having similar functions but manufactured by different vendors.

It should also be appreciated that the present invention may generally be implemented on any suitable object-oriented computer system. Therefore, the present examples are to be considered as illustrative and not restrictive, and the invention is not to be limited to the details given herein, but may be modified within the scope of the appended claims along with their full scope of equivalents.

1. A method of automatically detecting a number of application program interfaces (APIs) and/or remote methods associated with a server computer, comprising:
requesting a list of the APIs and/or the exported remote methods from the server computer; and
providing the list of APIs and/or remote methods in response to the request.

2. A method as recited in claim 1, wherein the requesting is associated with a client computer.

3. A method as recited in claim 2, further comprising:
sending a connection request to the server computer by the client computer based upon the list of APIs and/or remote methods; and
connecting to the server computer by the client computer.

4. A method for incorporating an electronic device into a network of electronic devices having at least one automatic API detection enabled server computer, comprising:
requesting a list of application programming interfaces (APIs) and/or exported remote methods from the electronic device to automatic API detection enabled server computer by the electronic device;
responding to the request by providing a comprehensive list of APIs and remote methods by the server computer to the electronic device; and
connecting to the server computer by the electronic device using the comprehensive list of application programming interfaces (APIs) and exported remote methods wherein the electronic device uses selected ones of the list of APIs and remote methods to communicate with other members of the network by way of the server computer.

5. A method as recited in claim 4, wherein the network is a heterogeneous network.

6. A method as recited in claim 4, wherein the electronic device is selected from a group that includes a PDA, a computer, a processor embedded appliance, a cell phone.

7. An apparatus for incorporating an electronic device into a network of electronic devices having at least one automatic API detection enabled server computer, comprising:
means for requesting a list of application programming interfaces (APIs) and/or exported remote methods from the electronic device to automatic API detection enabled server computer by the electronic device;
means for responding to the request by providing a comprehensive list of APIs and Remote methods by the server computer to the electronic device; and
means for connecting to the server computer by the electronic device using the comprehensive list of application programming interfaces (APIs) and exported remote methods wherein the electronic device uses selected ones of the list of APIs and remote methods to communicate with other members of the network by way of the server computer.

8. An apparatus as recited in claim 7, wherein the network is a heterogeneous network.

9. An apparatus as recited in claim 7, wherein the electronic device is selected from a group that includes a PDA, a computer, a processor embedded appliance, a cell phone.

10. A computer program product for incorporating an electronic device into a network of electronic devices having at least one automatic API detection enabled server computer, comprising:
computer code for requesting a list of application programming interfaces (APIs) and/or exported remote methods from the electronic device to automatic API detection enabled server computer by the electronic device;
computer code for responding to the request by providing a comprehensive list of APIs and remote methods by the server computer to the electronic device;
computer code for connecting to the server computer by the electronic device using the comprehensive list of application programming interfaces (APIs) and exported remote methods wherein the electronic device uses selected ones of the list of APIs and remote methods to communicate with other members of the network by way of the server computer; and
computer readable medium for storing the computer code.

11. A computer program product as recited in claim 10, wherein the network is a heterogeneous network.

12. A computer program product as recited in claim 10, wherein the electronic device is selected from a group that includes a PDA, a computer, a processor embedded appliance, a cell phone.

13. A method as recited in claim 4, further comprising:
requesting an action to be performed by the server computer by the client computer based upon the list of APIs, and remote methods;
performing the requested action by the server computer; and
confirming that the requested action has been successfully performed.

14. A method as recited in claim 4, wherein the client computer is one of a number of client computers each of which is embedded in a remotely located network appliance.

15. A method as recited in claim 14, wherein some of the network appliances operate under a first type protocol and wherein others of the network appliances operate under a second type protocol wherein the first and the second type protocols are different from each other.

16. A method as recited in claim 15, wherein each of the operation protocols has a particular list of APIs and/or remote methods associated therewith.

17. A method as recited in claim 15, wherein the server computer responds to the request for the list of APIs and/or remote methods with the list of APIs and/or remote methods only associated with the requesting network appliance.

18. A method as recited in claim 17, further comprising:
downloading an operating script associated with each of the requesting network appliances based upon the particular list of APIs and/or remote methods associated with the requesting device.

19. A method as recited in claim 18, wherein the script includes a set of operating instructions corresponding to the particular network appliance.

20. A method as recited in claim 19, wherein the script is a training program and the network appliance is a remotely operable training apparatus.
